(19) United States
(12) Patent Application Publication
(10) Pub. No.: US 2004/0105789 A1
(43) Pub. Date: Jun. 3, 2004

(54) Chemical reactor

(75) Inventor: Tadao Yamamoto, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 10/716,903

(22) Filed: Nov. 19, 2003

(30) Foreign Application Priority Data
Nov. 28, 2002 (JP) 2002-345419

(51) Int. Cl. B01J 19/00

(52) U.S. Cl. 422/130

(57) ABSTRACT

A chemical reactor includes a pair of substrates joined to each other, a micro flow path is provided between the pair of substrates. An injection section is provided to inject and supply a material to cause a chemical reaction into the flow path.

### CROSS-REFERENCE TO RELATED APPLICATIONS

This application is based upon and claims the benefit of priority from the prior Japanese Patent Application No. 2002-345419, filed Nov. 28, 2002, the entire contents of which are incorporated herein by reference.

### BACKGROUND OF THE INVENTION

1. Field of the Invention

This invention relates to a chemical reactor, and more particularly relates to a micro reactor.

2. Description of the Related Art

In a technical field of chemical reactions, a fuel reforming system which reforms a fuel, and a fuel cell which generates electricity with a reformed fuel gas reformed by the fuel reforming system are proposed as a chemical reactor in Jpn. Pat. Appln. KOKOKU Publication No. 2000-277139.

The chemical reactor system mentioned above uses a CO transformer and a CO selective oxidation reactor to lower concentration of toxic carbon monoxide which is a by-product produced when the fuel is reformed by a reformer. In such a configuration, air from the atmosphere outside the system is used as an oxidizing agent in order to oxidize carbon monoxide in the CO selective oxidation reactor. For this reason, not only the fuel cell but also a path for the CO selective oxidation reactor to communicate with the atmosphere outside the system are needed, which poses such a problem that if the path is too long, a size reduction of the chemical reactor will be hampered, and that shortening of the path restricts a layout of the CO selective oxidation reactor. To make the path shorter, it is desirable to locate the CO selective oxidation reactor as close to the outside of the chemical reactor system as possible. However, a reaction is caused at a temperature of 100° C. or higher in the CO selective oxidation reactor, so that in such a configuration, heat in the CO selective oxidation reactor is released outside the system to decrease heat efficiency and temperature of a surface of the chemical reactor system easily becomes high due to heat from a selective oxidative reaction, which poses a safety problem to users.

Furthermore, since oxygen concentration in the atmosphere accounts for 20% of the total, a gas whose volume is five times as high as that of a necessary amount of oxygen must be heated to a temperature required for the reaction when air is taken in to carry out oxidation, which causes such a problem as inefficient heating.

In addition, if an air intake port is provided in the chemical reactor system, components which exert an adverse effect on the reaction might enter the system together with air, so that it might be impossible to cause a stable reaction.

Therefore, an advantage of this invention is to provide a chemical reactor capable of stably providing an oxygen source.

### BRIEF SUMMARY OF THE INVENTION

A chemical reactor regarding one aspect of the present invention comprises:

a pair of substrates joined to each other;

a micro flow path provided between the pair of substrates; and

an injection section which injects and supplies a material to cause a chemical reaction into the flow path.

According to this aspect, since the injection section is provided which injects and supplies the material to cause a chemical reaction in the flow path, the material can be efficiently diffused in the flow path by the injection section, thus making it possible to promote the chemical reaction stably and rapidly to allow a size reduction of a flow path structure. If the injection section injects and supplies a material which can produce a necessary gas, there is no need for a path from the atmosphere to an oxidative reaction furnace to take in oxygen supplied for the oxidation of carbon monoxide, for example, thus allowing the entire reactor to be small.

Furthermore, a chemical reactor in another aspect of the present invention comprises:

a micro reactor which causes an oxidative reaction in a furnace; and

an oxidizing agent supply section which supplies a liquid oxidizing agent into the furnace.

According to the reactor in this aspect, it is possible to stably supply the oxidizing agent into the furnace in a volume smaller than when a gas-state oxidizing agent is taken in, because the oxidizing agent supply section supplies the liquid oxidizing agent.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing essential parts of one example of a fuel cell system comprising a compact chemical reactor according to this invention;

FIG. 2 is a perspective view of the essential parts of the compact chemical reactor as one embodiment of this invention;

FIG. 3 is a transmitted plan view of the compact chemical reactor shown in FIG. 2;

FIG. 4 is a cross sectional view along the line (IV)-(IV) of FIG. 3;

FIG. 5 is a cross sectional view along the line (V)-(V) of FIG. 3;

FIG. 6 is a schematic configuration diagram of a power generation section and a charging section shown in FIG. 1;

FIG. 7 is a transmitted plan view of the essential parts of the compact chemical reactor as another embodiment of this invention;

FIG. 8 is a cross sectional view along the line (VIII)-(VIII) of FIG. 7;

FIG. 9 is a block diagram showing essential parts of one example of a fuel cell system comprising the compact chemical reactor as still another embodiment of this invention;

FIG. 10 is a transmitted plan view of the compact chemical reactor shown in FIG. 9;

FIG. 11 is a cross sectional view along the line (XI)-(XI) of FIG. 10; and

FIG. 12 is a cross sectional view along the line (XII)-(XII) of FIG. 10.

### DETAILED DESCRIPTION OF THE INVENTION

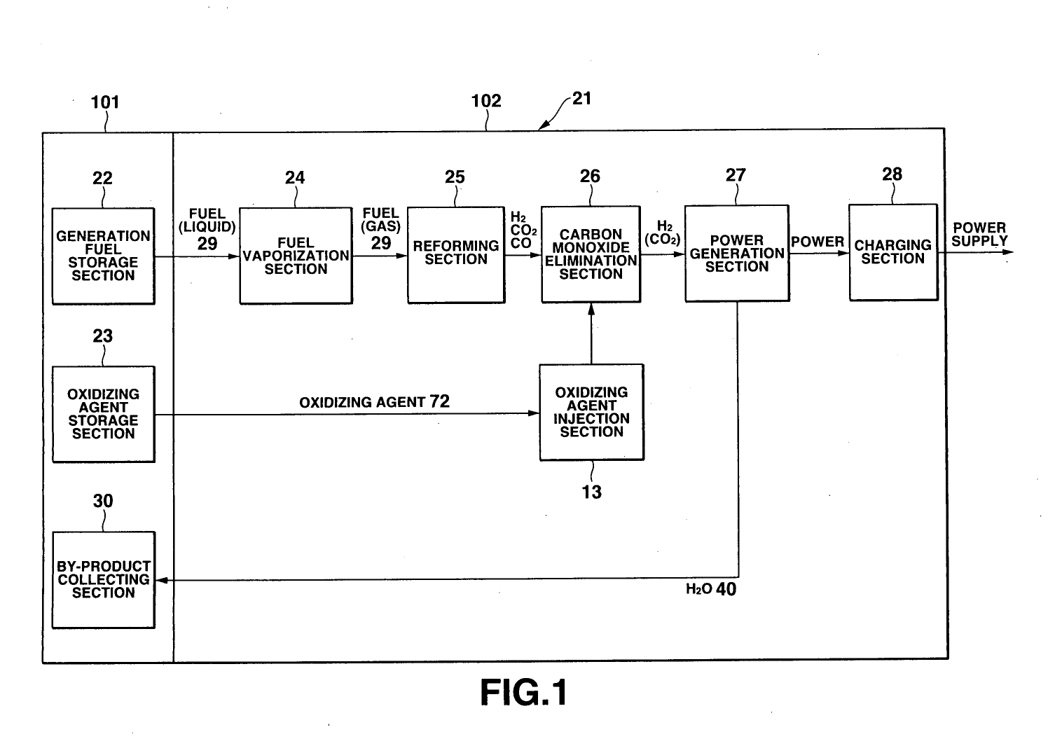

An application of a fuel cell system which comprises a compact chemical reactor according to this invention and which uses a fuel reforming type fuel cell will be described. FIG. 1 is a block diagram showing essential parts of one example of a fuel cell system 21. The fuel cell system 21 is roughly divided into a fuel package 101 and a power generation module 102.

The fuel package 101 has a generation fuel storage section 22 comprising a generation fuel storage container in which a generation fuel 29 (e.g., a methanol solution) is stored; an oxidizing agent storage section 23 comprising a small oxidizing agent storage container in which a liquid oxidizing agent 72 (e.g., hydrogen peroxide or its solution or a dinitrogen monoxide solution) is stored; and a by-product collecting section 30 which collects a by-product water 40 produced in the power generation module 102.

The power generation module 102 comprises an oxidizing agent injection section 13, a fuel vaporization section 24, a reforming section 25, a carbon monoxide elimination section 26, a power generation section 27, a charging section 28 and the like. The reforming section 25 is configured in the same way as the carbon monoxide elimination section 26 except that it is not coupled to the oxidizing agent injection section 13. The fuel vaporization section 24 has the same configuration as that of the reforming section 25 except that a catalyst is not formed in a flow path 16.

The fuel package 101 is detachable from the power generation module 102, and is coupled to the power generation module 102 to allow the generation fuel 29 in the generation fuel storage section 22 to be supplied to the fuel vaporization section 24 of the power generation module 102, to allow the oxidizing agent 72 in the oxidizing agent storage section 23 to be supplied to the oxidizing agent injection section 13 of the power generation module 102, and to allow the water 40 produced in the power generation module 102 to be collected by the by-product collecting section 30. Further, because it is detachable, a user of the fuel cell system 21 can remove the fuel package 101, in which the generation fuel 29 in the generation fuel storage section 22 is consumed and remains in a small amount, from the power generation module 102, so as to couple the new fuel package 101 in which the generation fuel 29 is filled in the generation fuel storage section 22 to the power generation module 102. The by-product collecting section 30 secures a capacity corresponding to water whose produced amount is expected depending on the amount of generation fuel 29 in the generation fuel storage section 22, and in an initial state of the fuel package 101, the water 40 is not present in the by-product collecting section 30 and an enough amount of oxidizing agent 72 to oxidize carbon monoxide which is expect to be produced depending on the generation fuel 29 filled in the generation fuel storage section 22 is stored in the oxidizing agent storage section 23, and the oxidizing agent 72 is consumed along with the consumption of the generation fuel 29.

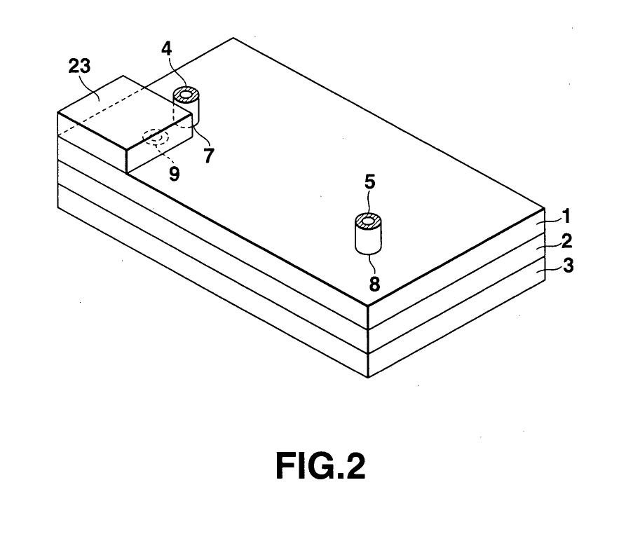

FIG. 2 is a perspective view of essential parts of the carbon monoxide elimination section 26 which is a compact chemical reactor called a micro reactor as one embodiment of this invention. This compact chemical reactor comprises a first substrate 1, a second substrate 2 and a third substrate 3 that are small-sized and laminated (e.g., anode-joined) on each other. In this case, the first and third substrates 1, 3 are made of glass, and the second substrate 2 is made of a metal such as silicon, aluminum or a metal alloy. At two predetermined portions of the first substrate 1, through openings 7, 8 are provided into which one end of an inflow tubule 4 and one end of an outflow tubule 5 are inserted.

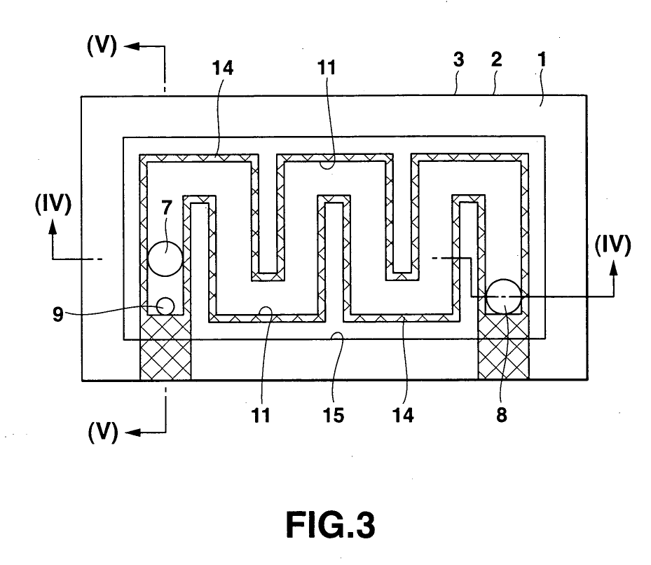

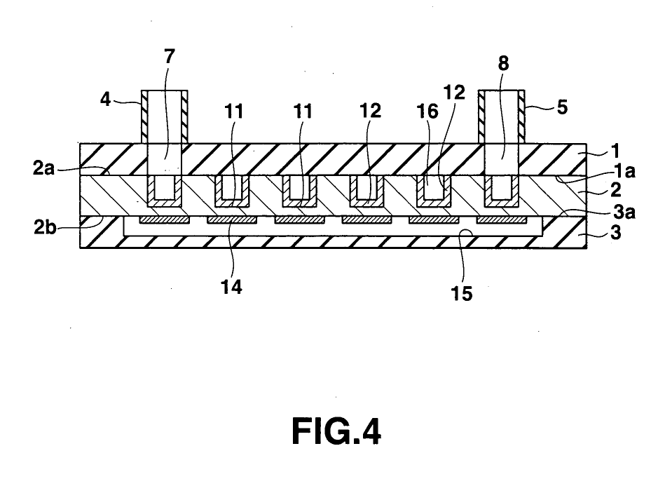

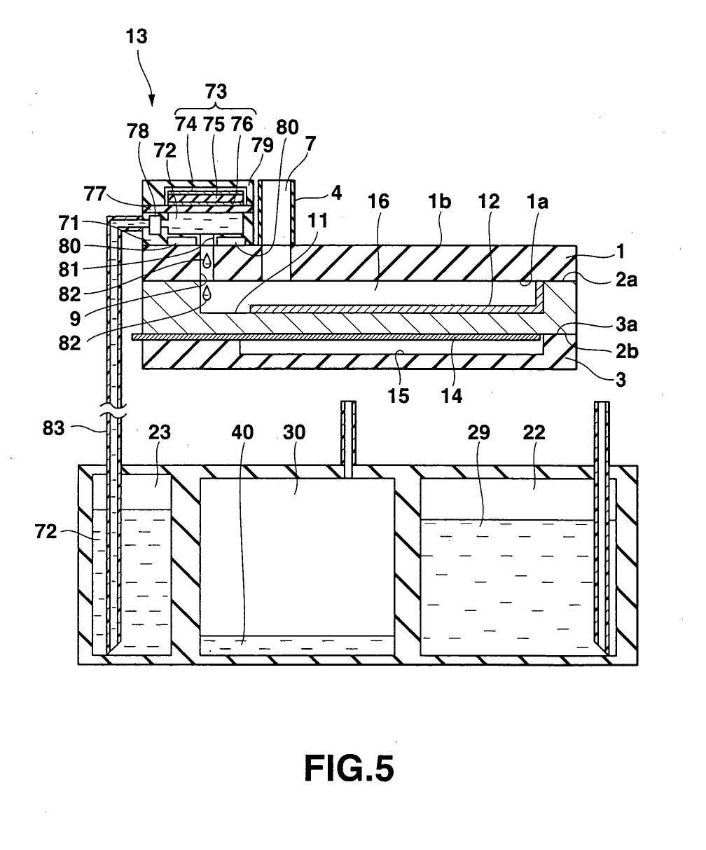

Next, FIG. 3 is a transmitted plan view of the compact chemical reactor shown in FIG. 2 when viewed from above, FIG. 4 is a cross sectional view along the line (IV)-(IV) of FIG. 3, and FIG. 5 is a cross sectional view along the line (V)-(V) of FIG. 3. On a surface 2a of the second substrate 2 facing the first substrate 1, a meandering micro groove 11 is formed by use of a micro fabrication technique accumulated by a semiconductor manufacturing technique. On the surface 2a of the second substrate 2, the groove 11 is covered with an opposite surface 1a of the first substrate 1 to form the flow path 16 which is a space where a fluid moves. The width and depth of the flow path 16 are both about 500 μm or less, and the length thereof is 100 mm to 300 mm, as one example.

A catalyst layer 12 is provided on a surface of the groove 11. The catalyst layer 12 has a structure in which a catalyst is supported by a porous film formed on the surface of the groove 11 of the second substrate 2. The vicinity of one end of the flow path 16 is connected to one end of the inflow tubule 4 via the opening 7 which penetrates the first substrate 1 in a thickness direction. The other end of the flow path 16 is connected to one end of the outflow tubule 5 via the opening 8 which penetrates the first substrate 1 in the thickness direction. In the first substrate 1, an opening 9 is provided in the vicinity of one end of the groove 11. On an upper surface 1b of the first substrate 1, the oxidizing agent injection section 13 is provided so as to cover the opening 9.

The oxidizing agent injection section 13 is an inkjet head, and is generally constituted of an oxidizing agent storage room 71 in which the liquid-phase oxidizing agent 72 is stored; a diaphragm 77 which partitions an upper surface of the oxidizing agent storage room 71 and is flexible toward a mechanical stress; an actuator 73 provided on an upper surface of the diaphragm 77; a pump 78 which sends the oxidizing agent 72 to the oxidizing agent storage room 71; and a housing 79 covering the actuator 73.

The oxidizing agent storage room 71 has heat insulating means 80 for thermal insulation between the oxidizing agent 72 in the oxidizing agent storage room 71 and the first substrate 1. A nozzle 81 is formed through the insulating layer 80 for injecting the oxidizing agent 72 toward the opening 9 provided in the upper surface 1b of the first substrate 1.

The actuator 73 has a pair of electrodes 74, 76 cover upper and lower surfaces of an electrostrictive element 75 having a dielectric polymer film made of silicon-based elastomer, acrylic elastomer, polyurethane elastomer or the like. The actuator 73 vibrates upward and downward in accordance with an electric signal input to the electrodes 74, 76 and propagates this vibration to the diaphragm 77. The actuator 73 may be a unimorph type actuator or a bimorph actuator.

The diaphragm 77 has restoring force against upward and downward bending, and after having been bent to decrease capacity of the oxidizing agent storage room 71, the diaphragm 77 returns to an original shape to restore the original capacity of the oxidizing agent storage room 71, or after having been bent to increase the capacity of the oxidizing agent storage room 71, the diaphragm 77 returns to the original shape to restore the original capacity of the oxidizing agent storage room 71. Therefore, the diaphragm 77 exerts pressure on the oxidizing agent 72 in the room 71 so that the capacity in the oxidizing agent storage room 71 decreases in accordance with the vibration of the actuator 73, and the oxidizing agent 72 is injected as liquid drops 82 from the nozzle 81.

The pump 78 pumps up the oxidizing agent 72 in the oxidizing agent storage section 23 described later via an oxidizing agent supply pipe 83 to take it into the oxidizing agent storage room 71, thereby maintaining the constant amount filling of the oxidizing agent 72 in the oxidizing agent storage room 71.

The insulating means 80 should most preferably has a space whose heat propagation properties and heat storage properties are low and whose internal pressure is 1 Pa or less, but may also be an inert gas.

The nozzle 81 is a hole having a small diameter so that the oxidizing agent 72 in the oxidizing agent storage room 71 does not leak to the first substrate 1 in a state where the actuator 73 is not vibrating.

The oxidizing agent 72, which is one of materials injected from the oxidizing agent injection section 13, may be in a liquid state or gas state at the time of injection depending on its physical properties, but should preferably be diffused in the flow path 16 as sufficiently as possible. When the oxidizing agent 72 is a gas at normal temperature, it should desirably be stored in a pressured and liquefied state in the oxidizing agent storage section 23. Further, the oxidizing agent supplied from the oxidizing agent storage section 23 or the oxidizing agent injected from the oxidizing agent injection section 13 may contain an addition agent such as a solvent or gas showing inertness to a reaction which oxidizes carbon monoxide in the groove 11.

A meandering thin film heater 14 formed of a resistive element thin film made of metal oxide such as TaSiOx or TaSiOxN, or a metal film is formed on the surface 2b of the second substrate 2 opposite to the third substrate 3. When a predetermined amount of heat is needed for chemical reaction (catalytic reaction or evaporation reaction) in each of the fuel vaporization section 24, reforming section 25 and carbon monoxide elimination section 26, the thin film heater 14 supplies predetermined heat energy to the catalyst layer 12 in the flow path 16 during the chemical reaction and can heat the inside of the flow path 16 to an optional temperature ranging from about normal temperature to 40° C. In this case, the meandering thin film heater 14 corresponds to the meandering flow path 16 in a planar sense, but may not correspond thereto. In addition, the thin film heater 14 may have an overlaying shape to cover the entire surface of the groove 11.

A concave portion 15 is formed in a central part of a surface 3a of the third substrate 3 facing the second substrate 2 by counter boring processing. A main part of the thin film heater 14 is disposed in the concave portion 15. The third substrate 3 not only protects the thin film heater 14 but also seals a gas with low thermal conduction in a space within the concave portion 15 to prevent thermal diffusion of the thin film heater 14, thereby improving thermal efficiency. A space whose internal pressure is about 1 Pa or less may be formed within the concave portion 15 for higher thermal insulation performance.

The fuel vaporization section 24 has the same configuration as that of the compact chemical reactor shown in FIG. 2 to FIG. 5. In this case, however, the catalyst layer 12 is not provided in the flow path 16. In addition, the opening 9 and the oxidizing agent injection section 13 are not provided. Further, the opening 7 coupled to the inflow tubule 4 is connected to the generation fuel storage section 22 which is the compact generation fuel storage container. The opening 7 is supplied with the generation fuel 29 of the generation fuel storage section 22 from an unshown pump. The pump may be configured in the same way as the oxidizing agent injection section 13, or may have a totally different configuration.

In the fuel vaporization section 24, when the generation fuel 29 is supplied to the one end of the flow path 16 from the pump, the generation fuel 29 is vaporized by heating (about 120° C.) of the thin film heater 14 in the flow path 16, and this vaporized generation fuel gas (e.g., CH₃OH+H₂O when the generation fuel 29 is a methanol solution) is let out from the outflow tubule 5.

The generation fuel gas (CH₃OH+H₂O) vaporized in the fuel vaporization section 24 is supplied to the reforming section 25. In this case, the reforming section 25 also has the same configuration as that of the compact chemical reactor shown in FIG. 2 to FIG. 5. However, the catalyst layer 12 includes a reforming catalyst made of, for example, Cu, ZnO or Al₂O₃ in this case. In addition, such injection sections as the opening 9 and the oxidizing agent injection section 13 are not provided. Further, the inflow tubule 4 is provided continuously from the outflow tubule 5 of the fuel vaporization section 24, and the outflow tubule 5 is coupled to the inflow tubule 4 of the carbon monoxide elimination section 26.

In the reforming section 25, when the generation fuel gas (CH₃OH+H₂O) from the fuel vaporization section 24 is supplied to the one end of the flow path 16 via the inflow tubule 4, an endothermic reaction as shown in the following equation (1) is caused by heating (about 280° C.) of the thin film heater 14 in the flow path 16, thereby producing hydrogen and by-product carbon dioxide.

CH₃OH⁺H₂O→3H₂+CO₂ (1)

Water (H₂O) on a left side of the above equation (1) may be water contained in the generation fuel 29 in the generation fuel storage section 22 at an initial stage of the reaction, but after a medium stage of the reaction, water produced along with power generation of the power generation section 27 described later may be collected to be supplied to the reforming section 25. In addition, a supply source of water (H₂O) on the left side of the above equation (1) during the power generation of the power generation section 27 may be only the power generation section 27, may be the power generation section 27 and the generation fuel storage section 22, or may be only the generation fuel storage section 22. At this time, a slight amount of carbon monoxide might be produced in the reforming section 25.

The products (hydrogen, carbon dioxide) on a right side of the above equation (1) and the slight amount of carbon monoxide are let out from the outflow tubule 5 of the reforming section 25. Out of those products let out from the outflow tubule 5 of the reforming section 25, hydrogen and carbon monoxide are supplied to the carbon monoxide elimination section 26, and carbon dioxide is separated to be released into the atmosphere.

The catalyst layer 12 of the carbon monoxide elimination section 26 includes a selective oxidative catalyst having Ru, PT or Al₂O₃, for example.

In the carbon monoxide elimination section 26, when hydrogen, carbon dioxide and carbon monoxide from the reforming section 25 are supplied to the one end of the flow path 16 via the outflow tubule 5, and when the liquid oxidizing agent is supplied to the one end of the flow path 16 from the oxidizing agent injection section 13, the following reaction is caused by heating (about 180° C.) of the thin film heater 14 in the flow path 16.

When the oxidizing agent 72 is hydrogen peroxide or its solution, oxygen and water are produced by decomposition of hydrogen peroxide as shown in the following equation (2), and as shown in the following equation (3), oxygen and carbon monoxide therein cause a reaction, thereby producing carbon dioxide.

2H₂O₂→O₂+2H₂O (2)

O₂+2CO→2CO₂ (3)

On the other hand, when the liquid oxidizing agent is a dinitrogen monoxide solution, the dinitrogen monoxide solution is vaporized to produce dinitrogen monoxide and water, of which dinitrogen monoxide and carbon monoxide cause a reaction as shown in the following equation (4), thereby producing nitrogen and carbon dioxide.

N₂O+CO→N₂+CO₂ (4)

A fluid that finally reaches the outflow tubule 5 of the carbon monoxide elimination section 26 mostly includes hydrogen and carbon dioxide (includes water and nitrogen in some cases).

The products after the series of reactions described above comprise hydrogen and carbon dioxide (includes water and nitrogen in some cases), but out of these products, carbon dioxide may be separated from hydrogen before reaching the power generation section 27, so as to be released into the atmosphere. In this case, a high concentration of hydrogen is supplied from the carbon monoxide elimination section 26 to the power generation section 27.

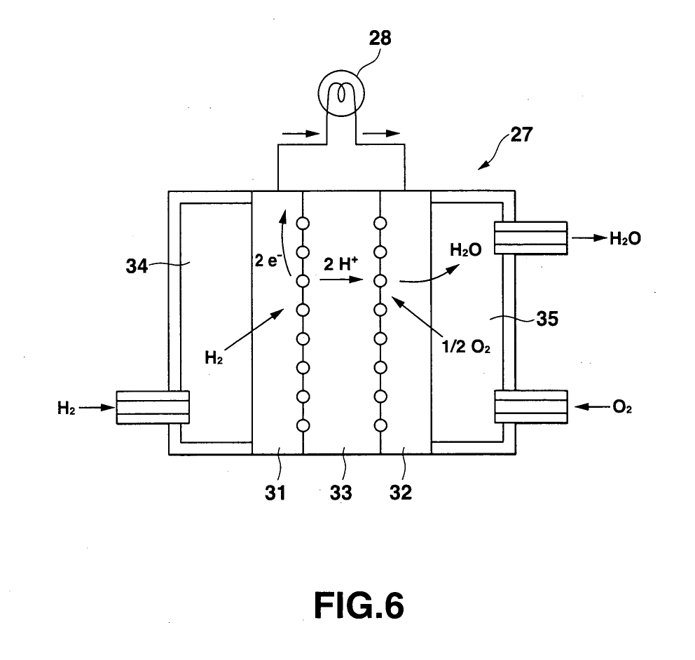

Next, the power generation section 27 and the charging section 28 will be described. The power generation section 27 comprises a known solid macromolecule type fuel cell as shown in FIG. 6. More specifically, the power generation section 27 is constituted by having an anode 31 comprising a carbon electrode to which catalysts including Pt, Ru, C or the like are stuck, and an cathode 32 comprising a carbon electrode to which catalysts including Pt, C or the like are stuck. A film-like ion conductive film 33 is placed between the anode 31 and the cathode 32, thereby supplying electric power to the charging section 28 constituted of a secondary cell or a capacitor provided between the anode 31 and the cathode 32.

In this case, a space section 34 is provided outside the anode 31. Hydrogen from the carbon monoxide elimination section 26 is supplied into the space section 34, and thus hydrogen is supplied to the anode 31. Also, a space section 35 is provided outside the cathode 32. Oxygen taken in from the atmosphere via the micro pump is supplied into the space section 35, and thus oxygen is supplied to the cathode 32.

Hydrogen ions (proton; H⁺) in which electrons (e⁻) are separated from hydrogen are produced on a side of the anode 31 as shown in the following equation (5), and pass to a side of the cathode 32 via the ion conductive film 33, and then the anode 31 takes out electrons (e⁻) therefrom which are supplied to the charging section 28.

H₂→2H⁺+2e⁻ (5)

On the other hand, electrons (e⁻) supplied by way of the charging section 28, hydrogen ions (H⁺) which have passed through the ion conductive film 33, and oxygen cause a reaction on the side of the cathode 32, thereby producing by-product water, as shown in the following equation (6).

2H⁺+(1/2)O₂+2e⁻→H₂O (6)

The series of electrochemical reactions described above (equation (5) and equation (6)) proceeds under an environment at a relatively low temperature of about room temperature to 80° C. Water is basically the only by-product except for electric power. The electric power generated by the power generation section 27 is supplied to the charging section 28, whereby the charging section 28 is charged.

Water as the by-product produced by the power generation section 27 is collected by the by-product collecting section 30 in the fuel package 101, but if at least part of water produced by the power generation section 27 is supplied to the reforming section 25 as described above, an amount of water to be initially sealed in the generation fuel storage section 22 can be reduced, and an amount of water to be collected can also be reduced.

The fuel applied to the fuel-reforming type fuel cell may be a fuel which is at least a liquid fuel or liquefied fuel or gas fuel containing hydrogen elements and from which electric energy can be generated by the power generation section 27 at a relatively high energy conversion efficiency. It is possible to satisfactorily apply fuels including alcoholic liquid fuels such as ethanol and butanol in addition to methanol mentioned above, liquid fuels made of hydrocarbons which are vaporized at ordinary temperature and at atmospheric pressure, for example, liquefied gases such as dimethyl ether, isobutane and natural gas (CNG), or a gas fuel such as a hydrogen gas.

An operation example of the oxidizing agent injection section 13 will here be shown.

An unshown control circuit is provided in the power generation module 102, and it checks a charging amount in the charging section 28. When the charging amount in the charging section 28 is not sufficient, the control circuit drives the pump so that it takes in the generation fuel 29 from the generation fuel storage section 22 of the fuel package 101 to supply it to the fuel vaporization section 24, and heats the fuel vaporization section 24, the reforming section 25 and the carbon monoxide elimination section 26 to a predetermined temperature. At this time, if the fuel cell of the power generation section 27 needs to generate electricity at a temperature higher than normal temperature, the control circuit sends a command so that heating means heat the power generation section 27 to a suitable temperature.

In the fuel vaporization section 24, when the generation fuel 29 of the generation fuel storage section 22 flows in from the opening 9, the generation fuel 29 is vaporized while flowing through the flow path 16 heated by the thin film heater 14. The generation fuel 29 vaporized in the fuel vaporization section 24 flows out to the outflow tubule 5 from the opening 8, and flows into the flow path 16 of the reforming section 25.

In the reforming section 25, when the vaporized generation fuel 29 contacts the catalyst layer 12, it is reformed to produce hydrogen as shown in the above equation (1). A fluid containing produced hydrogen flows out to the outflow tubule 5 from the opening 8, and flows into the flow path 16 of the reforming section 25.

In the carbon monoxide elimination section 26, the pump 78 has previously sent the oxidizing agent 72 in the oxidizing agent storage section 23 of the fuel package 101 to the oxidizing agent storage room 71 via the oxidizing agent supply pipe 83. The actuator 73 vibrates in accordance with a signal from the control circuit, and it injects the liquid drops 82 of the oxidizing agent 72 from the nozzle 81. An amount of the oxidizing agent 72 to be injected is such that it sufficiently oxidizes carbon monoxide whose produced amount is expected depending on the generation fuel 29 taken into the power generation module 102 from the generation fuel storage section 22. In other words, the amount of the oxidizing agent 72 to be injected is in accordance with the amount of the generation fuel 29 taken into the power generation module 102 from the generation fuel storage section 22. The liquid drops 82 are rapidly vaporized by the flow path 16 heated by the thin film heater 14. Then, a fluid containing hydrogen and carbon monoxide reformed in the fuel vaporization section 24 flows in from the inflow tubule 4, and is mixed with the oxidizing agent 72. The mixed oxidizing agent 72 and carbon monoxide cause the chemical reaction of the above equation (3) or (4) due to a catalytic action of the catalyst layer 12. The fluid supplied from the flow path 16 to the power generation section 27 has a significantly low concentration of carbon monoxide.

In the power generation section 27, since carbon monoxide is hardly contained in the fluid containing hydrogen taken into the space section 34, carbon monoxide rarely passes through the ion conductive film 33 to leak outside the power generation module 102.

The carbon monoxide elimination section 26 mentioned above is provided with the micro oxidizing agent injection section 13 for supplying the oxidizing agent 72 to the flow path 16, so that hydrogen peroxide or its solution which can produce, for example, oxygen gas can be efficiently diffused in the flow path by use of the micro oxidizing agent injection section 13. Thus the chemical reaction can be rapidly promoted, thereby allowing the flow path structure to be small and eliminating a conventionally needed air supply path which supplies air from an air supply device or the like to the carbon monoxide elimination section, which thus enables the entire reactor to be small and to be applied as a power supply for an apparatus with excellent portability. Further, because air is not used as the oxidizing agent 72, concentration of oxygen in the oxidizing agent 72 is high and a heating amount of the oxidizing agent 72 can be restricted. Also, because the oxidizing agent 72 is stored as a liquid in the generation fuel storage section 22, a greater amount of oxidizing agent can be stored than when it is stored in a gas-phase state. In addition, oxygen is liquefied as the oxidizing agent 72, a stable amount of oxygen can be supplied even if the reactor is small. This size reduction makes it easy to design the size and shape of the fuel cell system 21 itself so that they correspond to the size and shape of multipurpose chemical cells such as dry cells or batteries dedicated to a particular device, thus providing an advantage of excellent portability.

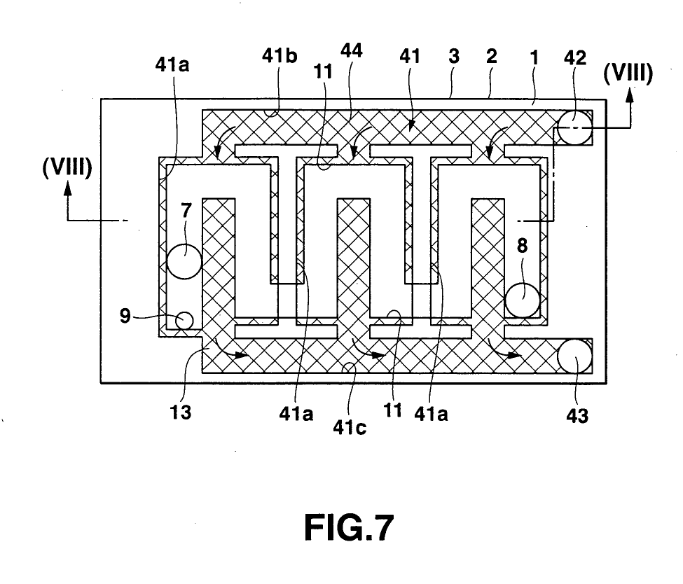

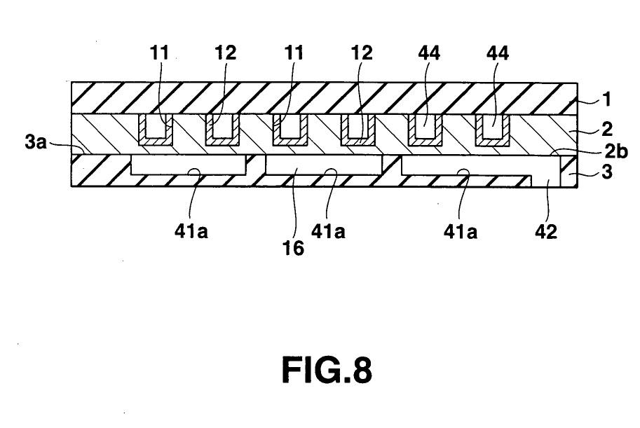

In the embodiment described above, the case where the thin film heater 14 is used as a heat source has been described, which is not limited. For example, another embodiment of this invention shown in FIG. 7 and FIG. 8 may be applied. FIG. 7 is a transmitted plan view of the essential parts of the compact chemical reactor as another embodiment of this invention, and FIG. 8 is a cross sectional view along the line (VIII)-(VIII) of FIG. 7.

In this case, the thin film heater is not provided on the surface 2b of the second substrate 2 facing the third substrate 3. Instead, a thermal fluid groove 41 is provided in the surface 3a of the third substrate 3 facing the second substrate 2. In this case, the thermal fluid groove 41 comprises a plurality of, for example, three isolated grooves 41a isolated from each other and provided in parts corresponding to a region where the groove 11 is formed; and a common inflow side groove 41b and a common outflow side groove 41c which are respectively provided on both sides of the region where the groove 11 is formed and which are connected to the three isolated grooves 41a. At predetermined two portions of the third substrate 3, a round inflow port 42 and outflow port 43 are provided and respectively connected to one end of the common inflow side groove 41b and one end of the common outflow side groove 41c. The fluid groove 41 is covered with the surface 2b of the second substrate 2 to form a flow path 44.

One end of a thermal fluid supplying pipe is inserted into the inflow port 42, and one end of a thermal fluid discharging pipe is inserted into the outflow port 43, which are not shown in the figures. The other end of the thermal fluid supplying pipe and the other end of the thermal fluid discharging pipe are respectively connected to both ends of a thermal fluid circuit having a micro pump and a heater provided outside the first to third substrates 1 to 3. When a high-temperature liquid such as silicon oil, or a high-temperature gas such as water vapor, air or nitrogen is supplied into the thermal fluid groove 41 as the thermal fluid heated by the heater, heat energy from the supplied thermal fluid heats the inside of the flow path 44 to a predetermined temperature.

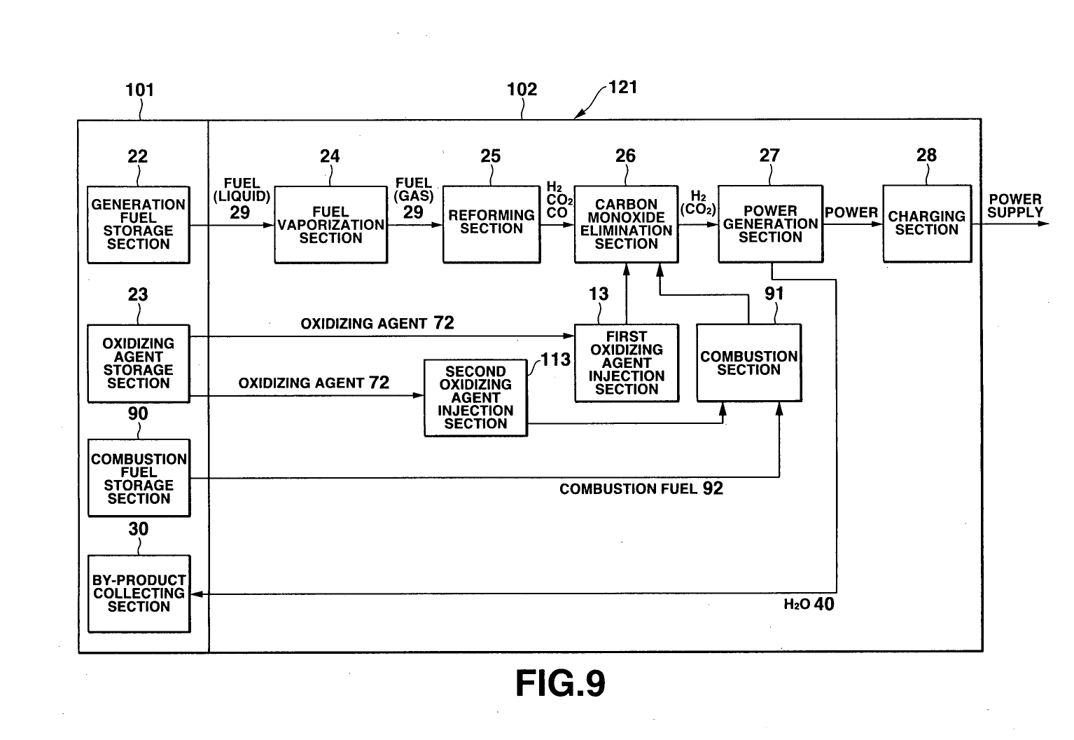

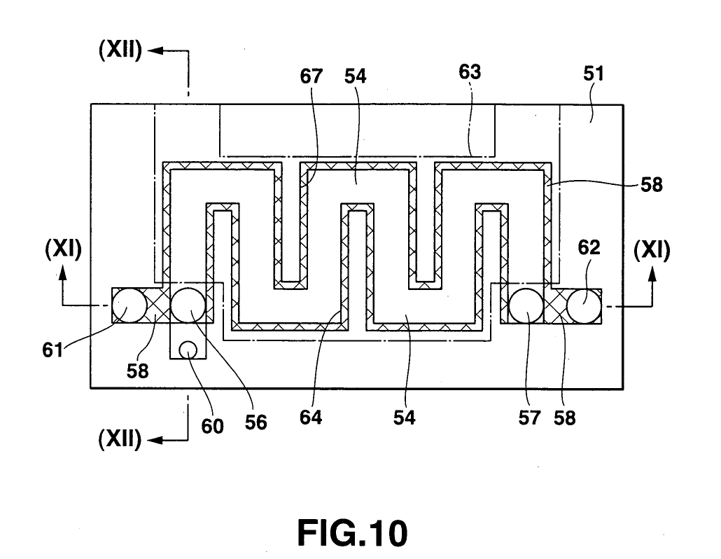

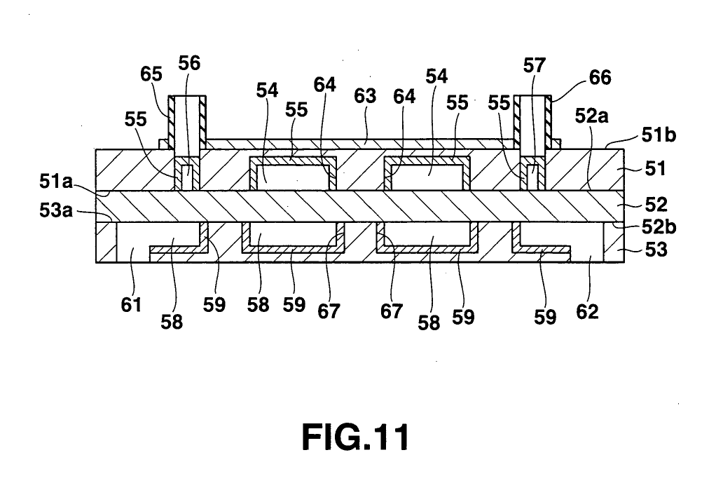

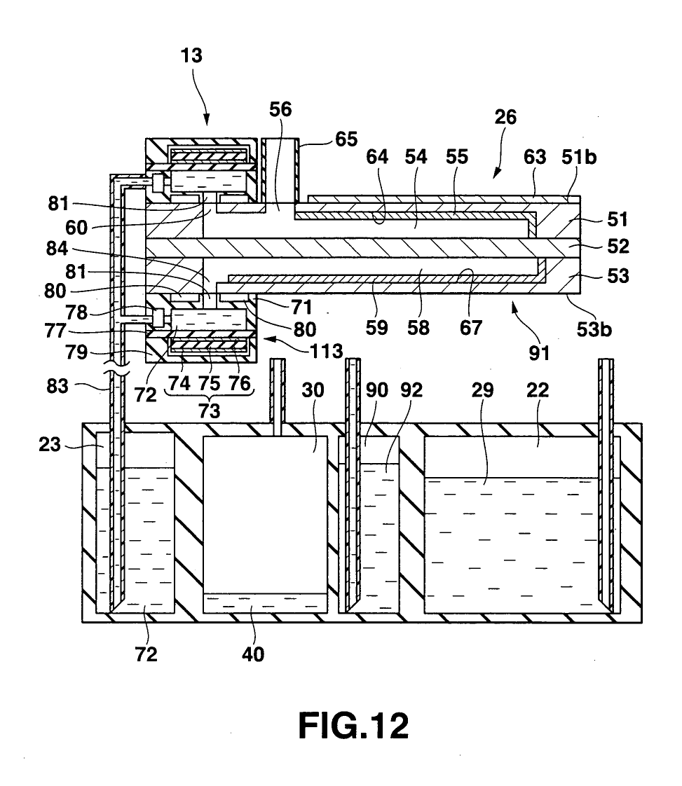

Still another embodiment of this invention shown in FIG. 9, FIG. 10, FIG. 11 and FIG. 12 may be applied. FIG. 9 is a block diagram showing essential parts of one example of a fuel cell system 121 in another embodiment, and the fuel cell system 121 has a configuration in which a combustion fuel storage section 90 is provided in the fuel package 101 of the fuel cell system 21 of FIG. 1 and a combustion section 91 is further provided in the power generation module 102 of the fuel cell system 21. The combustion fuel storage section 90 stores a combustion fuel 92 to be combusted in the combustion section 91. The combustion fuel 92 causes a chemical reaction in which it burns like, for example, methanol of high concentration to generate heat. The combustion section 91 combusts the combustion fuel 92 with the oxidizing agent 72 from the oxidizing agent storage section 23 as an oxygen source, and propagates combustion heat to the carbon monoxide elimination section 26. FIG. 10 shows a transmitted plan view of the essential parts of the compact chemical reactor as another embodiment of this invention, FIG. 11 shows a cross sectional view along the line (XI)-(XI) of FIG. 10, and FIG. 12 shows a cross sectional view along the line (XII)-(XII) of FIG. 10.

This chemical reactor is the carbon monoxide elimination section 26 of the power generation module 102, and the combustion section 91 is disposed below the carbon monoxide elimination section 26.

This compact chemical reactor comprises a first substrate 51, a second substrate 52 and a third substrate 53 that are small-sized and laminated (e.g., anode-joined) on each other. In this case, the first to third substrates 51 to 53 are all made of a metal such as silicon or aluminum, or a metal alloy. In a surface 51a of the first substrate 51 facing the second substrate 52, a meandering micro first groove 64 is formed by use of the micro fabrication technique accumulated by the semiconductor manufacturing technique, and the first groove 64 is covered with a surface 52a of the second substrate 52 facing the first substrate 51, and this covered space is a first flow path 54. The carbon monoxide elimination section 26 uses this first flow path 54 as a reaction furnace, and the width and depth of the first flow path 54 are both about 500 μm or less, as one example.

In the first flow path 54, a catalyst layer 55 including a catalyst made of, for example, Ru, PT or Al₂O₃ is provided on a surface of the first groove 64. The vicinity of one end of the first flow path 54 is connected to one end of an inflow tubule 65 via a through opening 56 formed in the first substrate 51. The other end of the first flow path 54 is connected to one end of an outflow tubule 66 via a through opening 57 formed in the first substrate 51. An opening 60 coupled to the nozzle 81 of the oxidizing agent injection section 13 is formed at the one end of the first flow path 54.

In a surface 53a of the third substrate 53 facing the second substrate 52, a meandering micro second groove 67 is formed by use of the micro fabrication technique accumulated by the semiconductor manufacturing technique. The second groove 67 is covered with a surface 52b of the second substrate 52 facing the third substrate 53. This covered space is a second flow path 58. The combustion section 91 uses this second flow path 58 as a reaction furnace, and the width and depth of the second flow path 58 are both about 500 μm or less, as one example. The second flow path 58 is formed meanderingly to cover the first flow path 54 in a planar manner so that the combustion heat in the second flow path 58 is efficiently transmitted to the first flow path 54.

A combustion catalyst layer 59 including a combustion catalyst is provided on a surface of the second groove 67 of the second flow path 58. One end side of the second flow path 58 branches into two, and an opening 61 penetrating the third substrate 53 is formed at an end of one branch path, and an opening 84 penetrating the third substrate 53 is formed at an end of the other branch path. Further, an opening 62 is formed at the other end of the second flow path 58. The opening 61 is coupled to the combustion fuel storage section of the fuel package 101 via an unshown pump. The opening 62 is connected to one end of a combustion gas discharge tubule (not shown). On an outer surface 53b of the third substrate 53, a second oxidizing agent injection section 113 is provided so that a nozzle 80 is coupled to the opening 84. The second oxidizing agent injection section 113 has the same configuration as that of the oxidizing agent injection section 13, and injects the oxidizing agent 72 from the oxidizing agent storage section 23 to the second flow path 58 via the opening 84.

On an outer surface 51b of the first substrate 51, a meandering thin film heater 63 formed of a resistive element thin film made of a metal oxide such as TaSiOx or TaSiOxN or other metals is formed. The thin film heater 63 is made of the same material as that of the thin film heater 14, and has functions of appropriately performing heating in accordance with a voltage signal from the control circuit to start a catalytic combustion reaction on the combustion catalyst layer 59 of the second flow path 58, and also promoting a catalytic reaction on the catalyst layer 55 of the first flow path 54 together with the combustion section 91.

A thin film temperature sensor (not shown) comprising a thin film thermister, a semiconductor thin film thermocouple and the like is provided at a predetermined potion in the vicinity of the first flow path 54. The thin film temperature sensor detects temperature in the first flow path 54, and provides its temperature detection signal to the control circuit in the fuel cell system 21. On the basis of this temperature detection signal, the control circuit in the fuel cell system 21 performs control so that an appropriate amount of the combustion fuel 92 of the combustion fuel storage section 90 is taken into the combustion section 91 and that the oxidizing agent 72 containing an amount of oxygen necessary for the combustion fuel 92 to be combusted is injected from the second oxidizing agent injection section 113 to the combustion section 91, in order to provide suitable temperature in the first flow path 54.

Next, part of operation of the compact chemical reactor as this carbon monoxide elimination section 26 will be described. The carbon monoxide elimination section 26 is heated by the thin film heater 63 which is heated in accordance with the control of the control circuit, and this heat is propagated to the combustion section 91 via the carbon monoxide elimination section 26. When the second flow path 58 of the combustion section 91 reaches a temperature that can start a combustion reaction, the second oxidizing agent injection section 113 injects the oxidizing agent 72 to the second flow path 58. The combustion fuel 92 of the combustion fuel storage section 90 is continuously supplied from the opening 61, and is mixed with the oxidizing agent 72 to cause a combustion reaction. When combustion heat of the combustion fuel storage section 90 reaches a temperature that promotes the chemical reaction in the first flow path 54 of the carbon monoxide elimination section 26, the second oxidizing agent injection section 113 injects an amount of the oxidizing agent 72 capable of oxidizing all carbon monoxide within the fluid in the first flow path 54 of the carbon monoxide elimination section 26 to the first flow path 54 via the opening 60. Then, a fluid containing carbon monoxide supplied to the first flow path 54 from the reforming section 25 via the opening 56 flows in, and carbon monoxide and oxygen in the oxidizing agent are mixed in the first flow path 54. At this time, the inside of the first flow path 54 is appropriately heated by the heat of the combustion section 91 and heat of the thin film heater 63, so that carbon monoxide causes the chemical reaction shown in the above equation (3) or (4), and the concentration of carbon monoxide in the fluid which has reached the power generation section 27 via the opening 57 is significantly low. In the second flow path 58 of the combustion section 91, a fluid such as carbon dioxide produced by the combustion is discharged from the opening 62. This fluid has little carbon monoxide therein, and causes no inconvenience if it is discharged outside the fuel cell system 121 as it is.

In the embodiment described above, the combustion fuel 92 and the liquid oxidizing agent 72 are supplied to the second flow path 58 from the different openings, but if the combustion fuel 92 and the oxidizing agent 72 can be equally mixed without causing a reaction, the combustion fuel 92 and the oxidizing agent 72 brought into a mixed state in the oxidizing agent storage room 71 can be injected from the nozzle 81.

The combustion section and the oxidizing agent injection section in the embodiment described above can be applied to heat the reforming section 25. In other words, by coupling the combustion section 91 and the oxidizing agent injection section 113 of FIG. 9 to the reforming section 25 similarly to the carbon monoxide elimination section 26, the reforming section 25 can be brought to a high temperature by the combustion reaction that requires oxygen. In this case, combustion is achieved by the supply of an appropriate amount of oxygen from the oxidizing agent injection section 113 without using oxygen in the atmosphere, thereby enabling a stale combustion reaction to be caused.

A micro injection section for supplying a mixture of the combustion fuel 92 (methanol) and hydrogen peroxide or its solution to the second flow path 58 of the reforming section 25 or to the second flow path 58 of the carbon monoxide elimination section 26 may be provided between the second substrate 52 and the third substrate 53, and this micro injection section supplies a mixture which can produce methanol gas and oxygen gas, thereby eliminating a conventionally needed air supply path for supplying oxygen from the outside and making it possible to stably supply oxygen.

In the compact chemical reactor shown in FIG. 10 to FIG. 13, the thin film heater 63 may be provided on an outer surface of the first substrate, and in this case, a substrate with the concave portion 15 that covers the thin film heater 63 may be disposed on an outer surface of the third substrate 53 or the outer surface of the first substrate as shown in FIG. 4. Further, instead of the thin film heater 63, the substrate 3 with a thermal fluid flow path 51 shown in FIG. 8 may be used. On the other hand, in the case shown in FIG. 2 to FIG. 5, the third substrate 3 may be omitted.

In the embodiments described above, the micro oxidizing agent injection section 13 injects a liquid material from the nozzle 81 in a particle form by vibration of the actuator 73 while controlling its injected amount, but may be such an injection section that injects the material in the nozzle in a particle form by pressure due to air bubbles that are produced in the nozzle by film boiling through heating the material in the nozzle or such an injection section that disperses the oxidizing agent 72 in the oxidizing agent storage room 71 in a vaporized state.

As described above, according to this invention, the compact injection section which injects and supplies a material into the flow path is provided between both the substrates in the vicinity of the flow path, so that the material can be efficiently diffused in the flow path by use of this compact injection section, and thus the chemical reaction can be rapidly and safely promoted, thereby allowing the flow path structure to be small and eliminating a conventionally needed path of air supplied for oxidizing carbon monoxide, which thus enables the entire reactor to be small.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A chemical reactor comprising:
a pair of substrates joined to each other;
a micro flow path provided between the pair of substrates; and
an injection section which injects and supplies a material to cause a chemical reaction into the flow path.

2. The chemical reactor according to claim 1, wherein the injection section is supplied with the material from a material storage container provided outside the pair of substrates.

3. The chemical reactor according to claim 1, wherein the material includes an oxidizing agent, and oxygen is produced from the injected oxidizing agent in the flow path.

4. The chemical reactor according to claim 3, wherein oxygen produced from the oxidizing agent and carbon monoxide contained in a differently supplied fluid react in the flow path to produce carbon dioxide.

5. The chemical reactor according to claim 1, wherein the material includes an oxidizing agent, and is mixed with a combustion fuel in the flow path to combust the combustion fuel, thereby generating heat energy.

6. The chemical reactor according to claim 1, wherein the material includes an oxidizing agent and a combustion fuel, the combustion fuel is combusted by the oxidizing agent in the flow path to generate heat energy.

7. The chemical reactor according to claim 1, wherein
the material includes a liquid oxidizing agent.

8. The chemical reactor according to claim 7, wherein
the material includes hydrogen peroxide or its solution or a dinitrogen monoxide solution.

9. The chemical reactor according to claim 1, wherein the injection section includes an inkjet head.

10. The chemical reactor according to claim 1, wherein the injection section includes an injection mechanism which injects the liquid material in a nozzle in a particle form by pressure due to air bubbles that are produced in the nozzle by film boiling through heating the material in the nozzle.

11. The chemical reactor according to claim 1, further comprising a heat source for heating the flow path.

12. The chemical reactor according to claim 11, wherein the heat source has a thin film heater.

13. The chemical reactor according to claim 11, wherein the heat source has a thermal fluid to be supplied in a flow path provided in a surface of one of the pair of substrates which is opposite to a surface facing the other substrate.

14. The chemical reactor according to claim 11, wherein the heat source has a combustion reaction furnace which achieves heating by combusting the combustion fuel.

15. The chemical reactor according to claim 14, further comprising an injection section which injects and supplies the combustion fuel.

16. A chemical comprising:
a micro reactor which causes an oxidative reaction in a furnace; and
an oxidizing agent supply section which supplies a liquid oxidizing agent into the furnace.

17. The chemical reactor according to claim 16, wherein the oxidizing agent supply section has an inkjet head.

18. The chemical reactor according to claim 16, wherein
the oxidizing agent includes hydrogen peroxide or its solution or a dinitrogen monoxide solution.
